(19) United States
(12) Patent Application Publication
(10) Pub. No.: US 2024/0271448 A1
(43) Pub. Date: Aug. 15, 2024

(54) CABLE EXTENSION FOR CORDLESS AUTOMATIC SWIMMING POOL CLEANER

(71) Applicant: ZODIAC POOL CARE EUROPE, Belberaud (FR)

(72) Inventors: Jordane Lacombe, Belberaud (FR); Simon Duffaut, Castelginest (FR)

(73) Assignee: ZODIAC POOL CARE EUROPE, Belberaud (FR)

(21) Appl. No.: 18/440,355

(22) Filed: Feb. 13, 2024

Related U.S. Application Data
(60) Provisional application No. 63/445,209, filed on Feb. 13, 2023.

(51) Int. Cl. E04H 4/16; H01R 13/523; H01R 31/06; H01R 35/04

(52) U.S. Cl. CPC E04H 4/1654; H01R 13/523; H01R 31/06; H01R 35/04

(57) ABSTRACT

Cordless automatic swimming pool cleaners may include cable extensions and associated systems and methods. The cable extensions described herein may facilitate both electrical power transmission as well as data transmission to and from the automatic swimming pool cleaner. The cable extensions may be selectively connected to an electrical connector on the cordless automatic swimming pool cleaner such that the cable extensions may be connected to or detached from the cordless automatic swimming pool cleaner.

### REFERENCE TO RELATED APPLICATION

This application claims the benefit of U.S. Provisional Patent Application No. 63/445,209, filed on Feb. 13, 2023, and entitled CABLE EXTENSION FOR CORDLESS AUTOMATIC SWIMMING POOL CLEANER, the content of which is hereby incorporated by reference in its entirety.

### FIELD OF THE INVENTION

The invention relates to systems and apparatuses for cleaning water-containing vessels such as swimming pools and spas and more particularly, although not necessarily exclusively, to automatic swimming pool cleaners (APCs).

### BACKGROUND OF THE INVENTION

Numerous cleaning devices capable of autonomous movement within swimming pools and spas currently exist. The most common of these devices are APCs, which often are either hydraulic or robotic in type. Hydraulic cleaners vary water flow for movement, while robotic cleaners typically employ electric motors to cause motion. Hydraulic APCs, furthermore, subdivide into “pressure-side” and “suction-side” cleaners, with pressure-side cleaners being fluidly connected to outputs of pumps of pool water circulation systems and suction-side cleaners being fluidly connected to inputs of such pumps. Many robotic APCs have onboard power sources such as a battery, thereby making the robotic APCs “cordless.” However, when the battery on the cordless APC is low or worn, a cleaning cycle cannot be performed.

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a cable extension for a cordless APC includes an electrical connector for selectively connecting to the cordless APC.

According to certain embodiments, a pool system includes a cordless APC and a cable extension. In some embodiments, the APC includes an onboard power source and an electrical connector releasably connectable with the electrical connector of the cable extension such that the cable extension is selectively connected to or detached from the cordless APC.

According to various embodiments, a charging system for a cordless APC includes a charger connectable to a power source and a cable extension.

Various implementations described herein can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figures, in which use of like reference numerals in different figures is intended to illustrate like or analogous components.

FIG. 1 illustrates a pool system according to embodiments.

### DESCRIPTION OF THE INVENTION

Described herein are cable extensions for cordless APCs and associated systems and methods. The cable extensions described herein may allow for a user to continue using the cordless APC regardless of the status of a battery onboard the APC. In certain embodiments, the cable extensions described herein may facilitate both electrical power transmission as well as data transmission to and from the APC. The cable extensions described herein may be selectively connected to an electrical connector on, in, and/or separated from a body of the cordless APC such that the cable extensions may be connected to or detached from the cordless APC as desired. In various embodiments, the cable extension may be a separate accessory and/or the cable extension may be integrated into a charger. In some embodiments, a connector on the cable extension may form a watertight or waterproof connection with the APC. In various embodiments, the cable extension includes an inductive connector that selectively connects with the APC. The connector(s) of the cable extension may be used as a swivel in certain embodiments. Various other benefits and advantages may be realized with the systems and methods provided herein, and the aforementioned advantages should not be considered limiting.

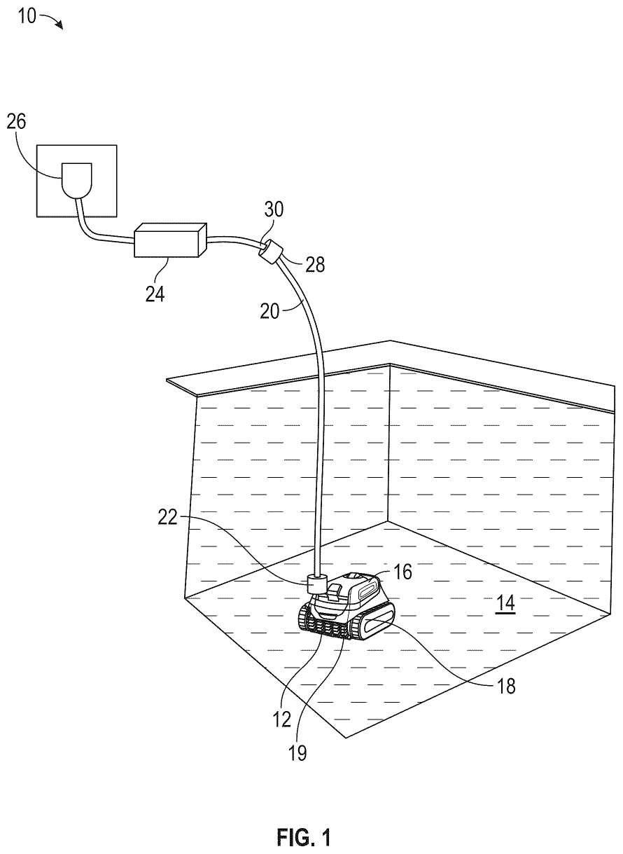

FIG. 1 illustrates a pool system 10 that includes an APC 12 for performing various operations within a pool or spa 14. The APC 12 generally includes a body 16, one or more motive elements 18, and one or more cleaning devices (including, but not limited to, a scrubber brush 19). The APC 12 is a cordless APC 12 and includes an onboard power source such as but not limited to one or more batteries. A motor, pump, filter, one or more batteries, and various other features may be provided on or within the APC 12 as desired. In various embodiments, a controller (e.g., processor and/or memory), an accelerometer, communication modules (e.g., an antenna, sensor, lights, speakers, etc.), combinations thereof, and/or other features and devices as desired may be included on the APC 12. Other non-limiting examples of APCs 12 may include those described in U.S. Pat. Nos. 10,316,534, 9,488,154, 8,578,538, and U.S. Patent Publication No. 2014/0303810, all of which are hereby incorporated by reference in their entireties.

In various embodiments, the APC 12 includes an electrical connector on the body 16, in the body 16, and/or separated from the body 16. The electrical connector may be used to selectively connect to a cable extension 20 as discussed in detail below. The electrical connector on the APC 12 may be various types of electrical connectors as desired. In some embodiments, the electrical connector on the APC 12 may form a watertight or waterproof connection with the cable extension 20 such that the connection between the APC 12 and the cable extension 20 may be submerged within the pool or spa 14. In certain embodiments, the electrical connector on the APC 12 may be an inductive connector. Optionally, the electrical connector on the APC 12 may be used as a swivel.

In various embodiments, the pool system 10 includes the cable extension 20 that may be selectively connected to the cordless APC 12 (i.e., the cable extension 20 may be connected to and/or detached from the cordless APC 12 as desired). In some embodiments, the cable extension 20 includes features or mechanisms such that the cable extension 20 is floating and/or at least partially buoyant in the pool or spa 14; however, in other embodiments, the cable extension 20 need not be floating.

The cable extension 20 includes an electrical connector 22 for selectively connecting with the electrical connector of the APC 12. The electrical connector 22 may be various types of electrical connectors as desired suitable for forming a releasable connection with the APC 12 that may be submerged. In certain embodiments, the electrical connector 22 mechanically and electrically connects to the electrical connector of the APC 12 to form a watertight or waterproof connection. In various embodiments, the electrical connector 22 is an inductive connector. The electrical connector 22 may be used as a swivel in some embodiments (e.g., one part of the electrical connector rotates or otherwise moves relative to another part of the electrical connector), although it need not be in other embodiments. In various embodiments, when the electrical connector 22 is connected to the corresponding connector on the cordless APC 12, the cable extension 20 may facilitate the transmission of electrical power to the cordless APC 12 and/or data to and/or from the APC 12.

In various embodiments, the pool system 10 includes a charger 24 that is connectable to a power source 26 and/or includes a power source. In some embodiments, the cable extension 20 may be integrated with the charger 24, meaning that the cable extension 20 is formed natively with the charger 24 and/or is not removable from the charger 24 absent destruction and/or disassembly. In other embodiments, and as illustrated in FIG. 1, the cable extension 20 may be a separate accessory that is selectively connected to the charger 24. In these embodiments, the cable extension 20 includes an intermediate electrical connector 28 that is selectively connected to a corresponding intermediate electrical connector 30 of the charger 24 (e.g., the cable extension 20 may be connected to and/or detached from the charger 24). In various embodiments, the intermediate electrical connectors 28, 30 may form a connection outside of the pool or spa 14 and need not form a connection that can be submerged.

When the cable extension 20 is connected to the charger 24 and the cordless APC 12, electrical power may be provided to the cordless APC 12 to power the APC 12 and allow the APC 12 to perform an operation (e.g., a cleaning cycle) and/or to charge the onboard battery of the APC 12.

Optionally, the charger 24 includes features (e.g., communication module, controller, etc.) such that data may be transmitted to and/or received from the APC 12 via the cable extension 20. Additionally, or alternatively, the cable extension 20 may be selectively connected to another external device (e.g., a control box or other device with or without a user interface) such that the external device may transmit data to and/or receive data from the APC 12 via the cable extension 20.

Exemplary concepts or combinations of features of the invention may include:
A. A cable extension for a cordless APC comprising an electrical connector for selectively connecting to the cordless APC.
B. The cable extension of any preceding or subsequent statement or combination of statements, wherein the cable extension is configured to float within a swimming pool or spa.
C. The cable extension of any preceding or subsequent statement or combination of statements, wherein the electrical connector is submergible in water.
D. The cable extension of any preceding or subsequent statement or combination of statements, wherein the cable extension supports the transmission of electrical power to the cordless APC and/or data to and/or from the APC.
E. The cable extension of any preceding or subsequent statement or combination of statements, wherein the electrical connector is a swivel connector such that one part of the electrical connector rotates or otherwise moves relative to another part of the electrical connector.
F. The cable extension of any preceding or subsequent statement or combination of statements, wherein the electrical connector is an inductive connector.
G. The cable extension of any preceding or subsequent statement or combination of statements, wherein the electrical connector is configured to form a waterproof or watertight connection with the cordless APC.
H. A pool system comprising a cordless APC and the cable extension of any preceding or subsequent statement or combination of statements, wherein the APC comprises an onboard power source and an electrical connector releasably connectable with the electrical connector of the cable extension such that the cable extension is selectively connected to or detached from the cordless APC.
I. The pool system of any preceding or subsequent statement or combination of statements, wherein the electrical connector of the APC is in or on a body of the APC or separated from the body by a cable.
J. The pool system of any preceding or subsequent statement or combination of statements, wherein the electrical connector of the APC is configured to form a waterproof or watertight connection with the electrical connector of the cable extension.
K. The pool system of any preceding or subsequent statement or combination of statements, wherein the electrical connector of the APC is an inductive connector.
L. The pool system of any preceding or subsequent statement or combination of statements, wherein the electrical connector of the APC is configured to swivel.
M. A charging system for a cordless APC comprising a charger connectable to a power source and the cable extension of any preceding or subsequent statement or combination of statements.
N. The charging system of any preceding or subsequent statement or combination of statements, wherein the cable extension is integral with the charger.
O. The charging system of any preceding or subsequent statement or combination of statements, wherein the charger further comprises a first intermediate connector and the cable extension further comprises a second intermediate connector, wherein the first intermediate connector and the second intermediate connector selectively connect the cable extension with the charger such that the cable extension is connected to or detached from the charger.
P. The charging system of any preceding or subsequent statement or combination of statements, wherein the first intermediate connector and/or the second intermediate connector are configured to swivel.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Further, although applicant has described devices and techniques for use principally with APCs, persons skilled in the relevant field will recognize that the present invention conceivably could be employed in connection with other objects and in other manners. Finally, references to “pools” and “swimming pools” herein may also refer to spas or other water containing vessels used for recreation, training, or therapy and for which cleaning of debris is needed or desired.

1. A pool system comprising:
a cordless automatic pool cleaner (APC); and
a cable extension comprising an electrical connector for selectively connecting to the cordless APC, wherein the APC comprises an onboard power source and an electrical connector releasably connectable with the electrical connector of the cable extension such that the cable extension is selectively connected to or detached from the cordless APC.

2. The pool system of claim 1, wherein the electrical connector of the APC is in or on a body of the APC or separated from the body by a cable.

3. The pool system of claim 1, wherein the electrical connector of the APC is configured to form a waterproof or watertight connection with the electrical connector of the cable extension.

4. The pool system of claim 1, wherein the electrical connector of the APC is an inductive connector.

5. The pool system of claim 1, wherein the electrical connector of the APC is configured to swivel.

6. The pool system of claim 1, wherein the cable extension is configured to float within a swimming pool or spa.

7. The pool system of claim 1, wherein the electrical connector is submergible in water.

8. The pool system of claim 1, wherein the cable extension supports the transmission of electrical power to the cordless APC and/or data to and/or from the APC.

9. The pool system of claim 1, wherein the electrical connector is a swivel connector such that one part of the electrical connector rotates or otherwise moves relative to another part of the electrical connector.

10. A charging system for a cordless automatic pool cleaner (APC) comprising a charger connectable to a power source and a cable extension comprising an electrical connector for selectively connecting to the cordless APC.

11. The charging system of claim 10, wherein the cable extension is integral with the charger.

12. The charging system of claim 10, wherein the charger further comprises a first intermediate connector and the cable extension further comprises a second intermediate connector, wherein the first intermediate connector and the second intermediate connector selectively connect the cable extension with the charger such that the cable extension is connected to or detached from the charger.

13. The charging system of claim 12, wherein the first intermediate connector and/or the second intermediate connector are configured to swivel.

14. The charging system of claim 10, wherein the cable extension is configured to float within a swimming pool or spa.

15. The charging system of claim 10, wherein the electrical connector is submergible in water.

16. The charging system of claim 10, wherein the cable extension supports the transmission of electrical power to the cordless APC and/or data to and/or from the APC.

17. A cable extension for a cordless automatic pool cleaner (APC) comprising an electrical connector for selectively connecting to the cordless APC.

18. The cable extension of claim 17, wherein the cable extension is configured to float within a swimming pool or spa and/or the electrical connector is submergible in water, and wherein the cable extension supports the transmission of electrical power to the cordless APC and/or data to and/or from the APC.

19. The cable extension of claim 17, wherein the electrical connector is a swivel connector such that one part of the electrical connector rotates or otherwise moves relative to another part of the electrical connector.

20. The cable extension of claim 17, wherein the electrical connector is an inductive connector.
